(19) United States
(12) Patent Application Publication
(10) Pub. No.: US 2013/0050045 A1
(43) Pub. Date: Feb. 28, 2013

(54) MULTIPLE-TURN LOOP ANTENNA ARRANGEMENT AND A PORTABLE RADIO COMMUNICATION DEVICE COMPRISING SUCH AN ARRANGEMENT

(71) Applicants: Marek Chacinski, Farsta (SE); Andrei Kaikkonen, Jarfalla (SE); Lukasz Grynczel, Sollentuna (SE); Per Erlandsson, Stockholm (SE); Peter Lindberg, Uppsala (SE)

(72) Inventors: Marek Chacinski, Farsta (SE); Andrei Kaikkonen, Jarfalla (SE); Lukasz Grynczel, Sollentuna (SE); Per Erlandsson, Stockholm (SE); Peter Lindberg, Uppsala (SE)

(21) Appl. No.: 13/589,226

(22) Filed: Aug. 20, 2012

(30) Foreign Application Priority Data
Aug. 22, 2011 (EP) 11178226.4

(51) Int. Cl. H01Q 7/00

(52) U.S. Cl. 343/848

(57) ABSTRACT

An exemplary embodiment includes a multiple-turn loop antenna arrangement comprising a multiple-turn loop element. The multiple-turn loop element is arranged in a first layer. A ground plane element is arranged in a second layer. The first and second layers are arranged in parallel. The multiple-turn loop element is arranged on top of the ground plane element. The ground plane element comprises slots interrupting eddy currents in the ground plane element, which would short signals in the multiple-turn loop element.

### CROSS-REFERENCE TO RELATED APPLICATION

This application claims benefit and priority of European Patent Application No. 11178226.4 filed Aug. 22, 2011. The entire disclosure of the above application is incorporated herein by reference.

### FIELD

The present disclosure relates to a multiple-turn loop antenna arrangement and a portable radio communication device comprising such an arrangement.

### BACKGROUND

This section provides background information related to the present disclosure which is not necessarily prior art.

Internal antennas have been used for some time in portable radio communication devices. There are a number of advantages connected with using internal antennas compared to protruding antennas. For example, internal antennas are small and light, making them suitable for applications wherein size and weight are of importance, such as in mobile phone, personal digital assistants (PDAs), portable computers, or similar devices.

But the application of internal antennas in a mobile phone puts some constraints on the configuration of the radiating element of the antenna. In particular, the space for an internal antenna arrangement is limited in a portable radio communication device. These constraints may make it difficult to find a configuration of the antenna arrangement that provides for desired use. This is especially true for antennas intended for use with radio signals of relatively low frequencies as the desired physical length of such antennas are large compared to antennas operating with relatively high frequencies.

One specific application operating in a relatively low frequency band is the Near Field Communication (NFC) application. The NFC operating band is about 13 Megahertz (MHz).

### SUMMARY

This section provides a general summary of the disclosure, and is not a comprehensive disclosure of its full scope or all of its features.

According to various aspects, exemplary embodiments are disclosed of multiple-turn loop antenna arrangements or assemblies. In an exemplary embodiment, a multiple-turn loop element is arranged in a first layer. A ground plane element is arranged in a second layer. The first and second layers are arranged in parallel. The multiple-turn loop element is arranged on top of the ground plane element. The ground plane element comprises slots interrupting eddy currents in the ground plane element, which would short signals in the multiple-turn loop element.

In another exemplary embodiment, a portable radio communication device generally includes a metal casing and a multiple-turn loop element arranged on the metal casing. The metal casing forms a ground plane element having slots arranged along the inside of the multiple-turn loop element. The slots are operable for interrupting eddy currents in the ground plane element.

Another exemplary embodiment of a portable radio communication device includes a metal casing and a multiple-turn loop element arranged on the metal casing. The metal casing forms a ground plane element having slots arranged along the inside of at least two parallel sides of the multiple-turn loop element. The multiple-turn element is an NFC antenna. The slots are operable for preventing eddy currents induced in the ground plane element NFC operation.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic drawing illustrating an NFC antenna arranged on top of a metal casing.

FIG. 2 is a schematic drawing illustrating a multiple-turn loop antenna arranged on top of a ground plane element having slots according to a first exemplary embodiment.

FIG. 3 is a schematic drawing illustrating a multiple-turn loop antenna arranged on top of a ground plane element having slots according to a second exemplary embodiment.

FIG. 4 is a schematic drawing illustrating multiple-turn loop antenna arranged partly off a ground plane element having slots according to a third exemplary embodiment.

### DESCRIPTION

Example embodiments will now be described more fully with reference to the accompanying drawings.

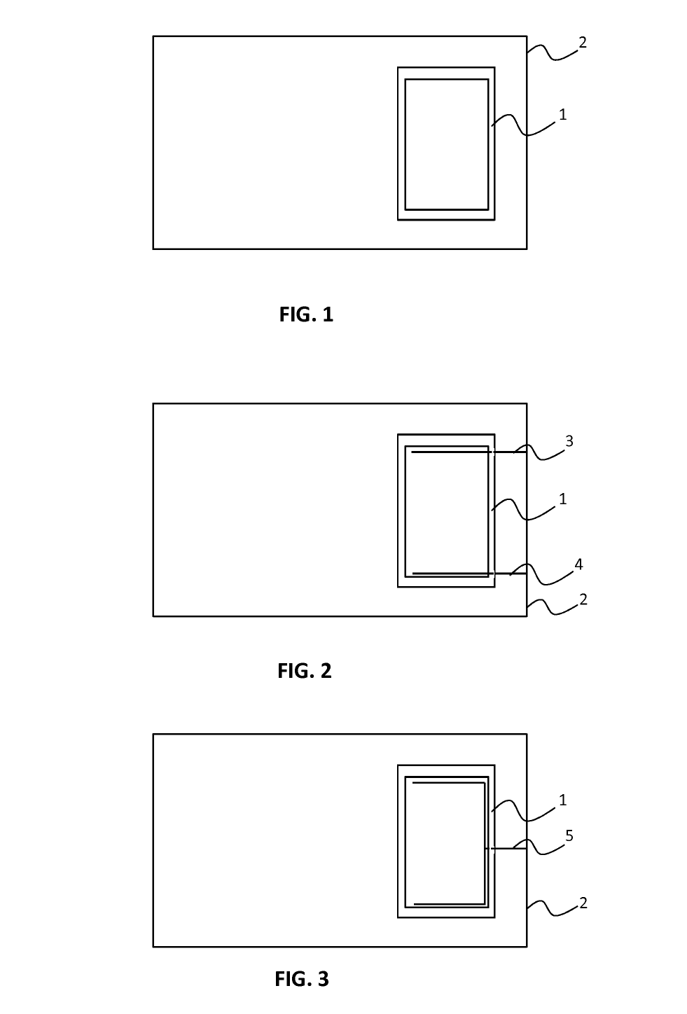

Multiple-turn loop elements, typically used for e.g. NFC antennas, will functionally be short-circuited when arranged on top of or under a metal casing forming a ground plane element as schematically illustrated in FIG. 1. Today, portable radio communication devices typically comprise a large ground plane element 2, which makes it difficult to provide a NFC antenna 1 therein. The NFC antenna 1 is schematically illustrated in FIG. 1 as a hollow square.

Disclosed herein are exemplary embodiments of multiple-turn loop antenna arrangements, which are not significantly affected by a close proximity ground plane element in a portable radio communication device. In an exemplary embodiment, a multiple-turn loop antenna arrangement generally includes a multiple-turn loop element arranged in a first layer and a ground plane element arranged in a second layer. The first and second layers are arranged in parallel and the multiple-turn loop element is arranged on top of the ground plane element. The ground plane element comprises slots interrupting eddy currents in the ground plane element, which would short signals in the multiple-turn loop element.

The multiple-turn loop element can be utilized as e.g. an NFC antenna despite being arranged on e.g. the inside or outside of a metal casing of a portable radio communication device, such as a smart phone. For NFC utilization, the multiple-turn loop element is preferably square-shaped.

The slots are preferably arranged along the inside of the multiple-turn loop element, in order to provide good interruption of eddy currents in the ground plane element. Even more preferably, the slots are arranged along the inside of two parallel sides of the multiple-turn loop element. Yet more preferably, the slots extend to an edge of the ground plane element.

In order to provide a single open point in the ground plane element, the slots are preferably arranged also along the inside of a third side of the multiple-turn loop element and extend in one point to an edge of the ground plane element. The ground plane element is advantageously a metal cover for a portable radio communication device.

The multiple-turn loop element is preferably an NFC antenna. When available space in a portable radio communication device allows off-ground positioning of the multiple-turn loop element, a side of the multiple-turn loop element is preferably arranged off the ground plane element.

Exemplary embodiments are also provided of portable radio communication devices that include such multiple-turn loop antenna arrangements. As used herein, the term radiating element is intended to cover electrically conductive elements arranged for receiving and/or transmitting radio signals.

FIG. 2 illustrates a first exemplary embodiment of a multiple-turn loop antenna arrangement for a portable radio communication device (e.g., a mobile phone or similar device, etc.). As shown, the multiple-turn loop antenna arrangement comprises a multiple-turn loop element 1 arranged in a first layer. A ground plane element 2 is arranged in a second layer. The first and second layers are arranged in parallel. The multiple-turn loop element 1 is arranged on top of the ground plane element 2. The multiple-turn loop element 1 comprises a plurality of turns, concentrically arranged in a planar plane, which schematically has been illustrated as a hollow square in FIG. 2. Although the multiple-turn loop element 1 has been illustrated as square-shaped, the element 1 could alternatively have other shapes, such as e.g. a circular shape, etc.

Even though the multiple-turn loop element 1 is described as being arranged on top of the planar element 2, the multiple-turn loop antenna arrangement can be used with the multiple-turn loop element 1 facing away from the portable radio communication device or facing towards the portable radio communication device.

For providing galvanic isolation between the multiple-turn loop element 1 and the ground plane element 2, a dielectric film layer is typically arranged there between. Advantageously, the multiple-turn loop antenna arrangement is configured for NFC.

With continued reference to FIG. 2, the ground plane element 2 comprises two slots 3 and 4 arranged along the inside of two parallel sides of the multiple-turn loop element 1. The slots 3 and 4 extend to the end of the ground plane element 2, and thus are two open ended slots. By this configuration, eddy currents induced in the ground plane element 2 by e.g. NFC operation are prevented. The slots 3 and 4 are preferably only a fraction of 1 millimeter (mm) wide. Possible addition of components across the slots is acceptable as long as the series capacitance is less than 1 picofarad (pF) for NFC operation.

The slots 3 and 4 should preferably extend at least ⅔ of the length of the sides of the multiple-turn loop element 1, or more preferably along the whole length of the sides of the multiple-turn loop element 1. Even longer slots work, but does not increase performance much.

FIG. 3 illustrates a multiple-turn loop antenna arrangement according to a second exemplary embodiment. This second embodiment is identical to the first exemplary embodiment described above apart from the following.

In this second exemplary embodiment, the slots 5 along the inside of the multiple-turn loop element 1 are connected and extend in a common open end of the ground plane element 2. The connection is preferably along an inside of the multiple-turn loop element 1.

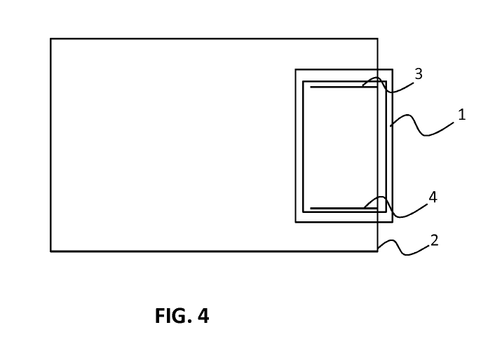

FIG. 4 illustrates a multiple-turn loop antenna arrangement according to a third exemplary embodiment. This third exemplary embodiment is identical to the first exemplary embodiment describe above apart from the following.

The multiple-turn loop element 1 is arranged partly off-ground the ground plane element 2, preferably having one side of the square-shaped multiple loop element 1 extending off the ground plane element 2. In this way, the slots 3 and 4 do not need to cross that side of the square-shaped multiple loop element 1 to be open ended.

The multiple-turn loop antenna arrangement is typically generally planar, but may e.g. be partly folded over the top edge of a mobile phone to facilitate e.g. NFC operation. The multiple-turn loop element 1 may in this way be provided completely over or partially over the ground plane element 2 of the portable radio communication device.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed:

1. A multiple-turn loop antenna arrangement comprising:
a multiple-turn loop element arranged in a first layer; and
a ground plane element arranged in a second layer;
wherein:
the first and second layers are arranged in parallel;
the multiple-turn loop element is arranged on top of the ground plane element; and
the ground plane element comprises slots for interrupting eddy currents in the ground plane element, which would short signals in the multiple-turn loop element.

2. The multiple-turn loop antenna arrangement of claim 1, wherein the multiple-turn loop element is square-shaped.

3. The multiple-turn loop antenna arrangement of claim 1, wherein the slots are arranged along the inside of the multiple-turn loop element.

4. The multiple-turn loop antenna arrangement of claim 3, wherein the slots are arranged along the inside of two parallel sides of the multiple-turn loop element.

5. The multiple-turn loop antenna arrangement of claim 4, wherein the slots extend to an edge of the ground plane element.

6. The multiple-turn loop antenna arrangement of claim 4, wherein the slots are arranged also along the inside of a third side of the multiple-turn loop element and extend in one point to an edge of the ground plane element.

7. The multiple-turn loop antenna arrangement of claim 1, wherein the ground plane element is a metal cover for a portable radio communication device.

8. The multiple-turn loop antenna arrangement of claim 1, wherein the multiple-turn loop element is an NFC antenna.

9. The multiple-turn loop antenna arrangement of claim 8, wherein the slots are operable for preventing eddy currents induced in the ground plane element NFC operation.

10. The multiple-turn loop antenna arrangement of claim 1, wherein a side of the multiple-turn loop element is arranged off the ground plane element.

11. The multiple-turn loop antenna arrangement of claim 1, wherein the slots comprise two open ended slots that extend to an end of the ground plane element.

12. The multiple-turn loop antenna arrangement of claim 1, wherein the slots are connected and extend in a common open end of the ground plane element along an inside of the multiple-turn loop element.

13. A portable radio communication device comprising the multiple-turn loop antenna arrangement of claim 1.

14. The portable radio communication device of claim 10, wherein the multiple-turn loop element is arranged on an inside or outside of a metal casing of the portable radio communication device.

15. A portable radio communication device comprising:
a metal casing; and
a multiple-turn loop element arranged on the metal casing;
wherein the metal casing forms a ground plane element having slots arranged along the inside of the multiple-turn loop element;
whereby the slots are operable for interrupting eddy currents in the ground plane element.

16. The portable radio communication device of claim 15, wherein:
the multiple-turn loop element is arranged on an outside or an inside of the metal casing; and/or
the slots are arranged along the inside of two parallel sides of the multiple-turn loop element; and/or
the slots are arranged also along the inside of a third side of the multiple-turn loop element and extend in one point to an edge of the ground plane element.

17. The portable radio communication device of claim 15, wherein:
the slots comprise two open ended slots that extend to an end of the ground plane element; or
the slots are connected and extend in a common open end of the ground plane element along an inside of the multiple-turn loop element; or
a side of the multiple-turn loop element is arranged off the ground plane element.

18. The portable radio communication device of claim 15, wherein:
the multiple-turn loop element is an NFC antenna; and
the slots are operable for preventing eddy currents induced in the ground plane element NFC operation.

19. A portable radio communication device comprising:
a metal casing; and
a multiple-turn loop element arranged on the metal casing;
wherein the metal casing forms a ground plane element having slots arranged along the inside of at least two parallel sides of the multiple-turn loop element, and the multiple-turn element is an NFC antenna;
whereby the slots are operable for preventing eddy currents induced in the ground plane element NFC operation.

20. The portable radio communication device of claim 19, wherein:
the slots comprise two open ended slots that extend to an end of the ground plane element; or
the slots are arranged also along the inside of a third side of the multiple-turn loop element and extend in one point to an edge of the ground plane element such that the slots are connected in a common open end; or
a side of the multiple-turn loop element is arranged off the ground plane element.
